(19) United States
(12) Patent Application Publication
(10) Pub. No.: US 2018/0164795 A1
(43) Pub. Date: Jun. 14, 2018

(54) FAN MONITORING SYSTEM

(71) Applicants: INVENTEC (PUDONG) TECHNOLOGY CORPORATION, Shanghai City (CN); INVENTEC CORPORATION, Taipei City (TW)

(72) Inventor: Ying-Xian HAN, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 15/831,380

(22) Filed: Dec. 4, 2017

(30) Foreign Application Priority Data
Dec. 14, 2016 (CN) 201611152851.3

(51) Int. Cl. G05B 23/02; G06F 1/20; G06F 11/30; G08B 5/36; G08B 21/18

(52) U.S. Cl. CPC G05B 23/0235; G06F 1/206; G08B 21/18; G08B 5/36; G06F 11/30

(57) ABSTRACT

A fan monitoring system includes a first fan, a complex programmable logic device and a fan status notification module. The first fan operates according to a signal of first fan rotating speed and generates a first impulse signal having a first impulse frequency value. The complex programmable logic device counts a time period of continuously receiving the first impulse signal having the first impulse frequency value remaining consistent. The complex programmable logic device determines that the first fan operates abnormally and generates a first fan error signal when determining that the first impulse frequency value reaches a first peak and the time period of continuously receiving the first impulse signal having the first impulse frequency value remaining consistent is greater than a first predetermined time value. The fan status notification module displays a first fan error status notification when receiving the first fan error signal.

### CROSS-REFERENCE TO RELATED APPLICATIONS

This non-provisional application claims priority under 35 U.S.C. § 119(a) on Patent Application No(s). 201611152851.3 filed in China on Dec. 14, 2016, the entire contents of which are hereby incorporated by reference.

### TECHNICAL FIELD

The disclosure relates to a fan monitoring system, more particularly a fan monitoring system for a server.

### BACKGROUND

In general, a server is equipped with a plurality of components such as a computer case, a power supply, a mainboard, storages or baseboard management controllers (BMC). The baseboard management controllers of the server are mainly used for collecting information regarding operating conditions, system statuses of the server, etc. Wherein the information collected by the baseboard management controllers includes rotating speeds of fans. In other words, the server is capable of displaying the current rotating speed of the fans through the baseboard management controllers. The baseboard management controllers display abnormal information and turns off the system power of the server when discovering that the rotating speeds of fans are incompatible with predetermined values. However, some new servers are not equipped with baseboard management controllers. In this condition, those new servers are not capable of controlling fans in the computer case of the server. Furthermore, those new servers are not capable of monitoring and displaying the rotating speed of each fan in the server. Therefore, effectively controlling the fans in the computer case becomes a problem to those new servers without baseboard management controllers.

### SUMMARY

A fan monitoring system adapted to a server is disclosed according to one embodiment of the present disclosure. The fan monitoring system includes a first fan, a complex programmable logic device and a fan status notification module. The first fan is configured to receive a signal of first fan rotating speed and operate according to the signal of first fan rotating speed, and generate a first impulse signal having a first impulse frequency value. The complex programmable logic device is communicatively connected to the first fan and configured to receive the first impulse signal. The complex programmable logic device is configured to count a time period of continuously receiving the first impulse signal having the first impulse frequency value remaining consistent. When the complex programmable logic device determines that the first impulse frequency value reaches the first peak and the time period of continuously receiving the first impulse signal having the first impulse frequency value remaining consistent is greater than a first predetermined time value, the complex programmable logic device determines that the first fan operates abnormally and generates a first fan error signal. The fan status notification module is electrically connected to the complex programmable logic device. The fan status notification module displays a first fan error status notification when receiving the first fan error signal.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a fan monitoring system according to one embodiment of the present disclosure;

FIG. 2 is a schematic diagram for counting a time period of a first impulse signal according to one embodiment of the present disclosure; and

FIG. 3 is a schematic diagram for counting a time period of a first initial impulse signal according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

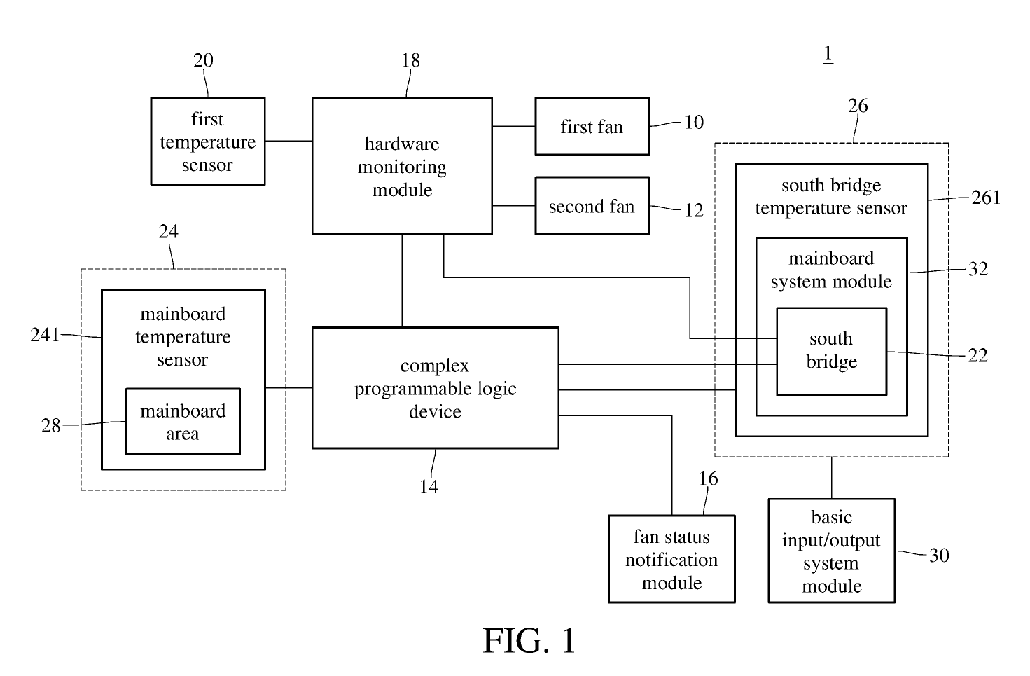

Please refer to FIG. 1, which is a block diagram of a fan monitoring system according to one embodiment of the present disclosure. As shown in FIG. 1, the fan monitoring system 1 is adapted to a server. The fan monitoring system 1 includes a first fan 10, a complex programmable logic device 14 and a fan status notification module 16. The first fan 10 is configured to receive a signal of first fan rotating speed, operate according to the signal of first fan rotating speed and generate a first impulse signal. In this embodiment, the first fan 10 is a cooling fan adapted to central processing units (CPU). In other embodiments, the first fan 10 is a cooling fan adapted to other computer hardware. The first impulse signal has a first impulse frequency value, which is an operating frequency value of the first fan 10, such as 10 hertz (HZ).

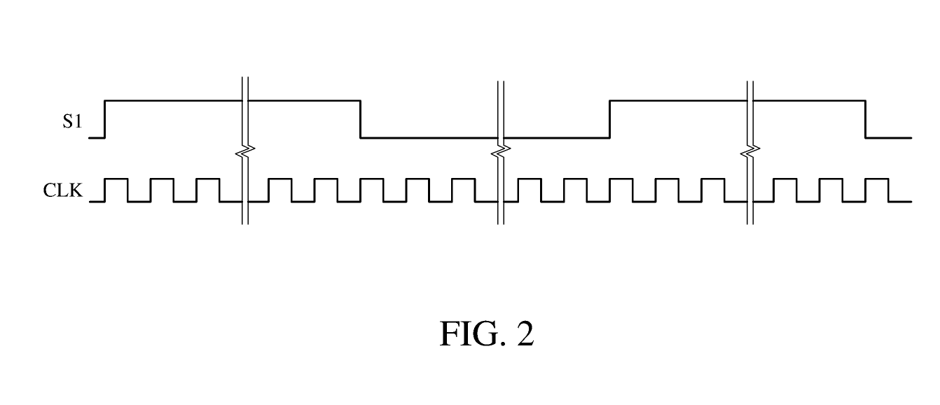

The complex programmable logic device 14 is communicatively connected to the first fan 10. When the complex programmable logic device 14 receives the first impulse signal from the first fan 10, the complex programmable logic device 14 counts a time period of continuously receiving the first impulse signal having the first impulse frequency value remaining consistent. The time period is a duration that the first impulse has a consistent first impulse frequency value. For example, please refer to FIG. 1 and FIG. 2. FIG. 2 is a schematic diagram for counting a time period of the first impulse signal according to one embodiment of the present disclosure. As shown in FIG. 2, assume the first impulse signal S1 is kept at 100 milliseconds, which means that the first impulse frequency value is 10 Hz. When the complex programmable logic device 14 receives the first impulse signal S1 having the impulse frequency value which is 10 Hz, the complex programmable logic device 14 counts the time period of the first impulse signal S1.

As shown in FIG. 2, in another embodiment of the present disclosure, the complex programmable logic device 14 generates the time period of continuously receiving the first impulse signal having the first impulse frequency value remaining consistent by counting the first impulse signal S1 according to a clock frequency CLK. When the first impulse frequency value reaches the first peak, it is indicated that the first impulse frequency value reaches a predetermined maximum peak. If the complex programmable logic device 14 obtains the time period of continuously receiving the first impulse signal having the first impulse frequency value remaining consistent, which is greater than a first predetermined time value, then the complex programmable logic device 14 determines that the first fan operates abnormally, and generates a first fan error signal. In this embodiment, the first impulse frequency value reaches the first peak, and time period of continuously receiving the first impulse signal having the first impulse frequency value remaining consistent in FIG. 2 is 12 seconds, which is greater than the first predetermined time value which is 10 seconds. Therefore, it is found that the first fan keeps operating at the maximum rotating speed for more than the first predetermined time value which 10 seconds. Then, the complex programmable logic device 14 determines that the first fan does not operate normally and generates a first fan error signal.

After the complex programmable logic device 14 generates the first fan error signal, the fan status notification module 16 receives the first fan error signal and displays a first fan error status notification. In one embodiment, the fan status notification module 16 has one or more light-emitting diodes (LED). Through displaying colorful light (e.g. red lights), the users are notified that the first fan 10 operates abnormally and is incapable of providing the function of cooling. Therefore, the users know that the repairs for the first fan 10 are required.

In one embodiment, the fan monitoring system 1 further includes a hardware monitoring module 18. The hardware monitoring module 18 is electrically connected to the complex programmable logic device 14 and the first fan 10 respectively. As shown in FIG. 1, the complex programmable logic device 14 receives the first impulse signal S1 and sends the signal of first fan rotating speed to the first fan 10 through the hardware monitoring module 18 for controlling the operation of the first fan 10. In the embodiment, the hardware monitoring module 18 has the function of Pulse Width Modulation (PWM), which is capable of converting the signal of first fan rotating speed to a pulse having a constant period for controlling the operation of the first fan 10. Moreover, the hardware monitoring module 18 monitors the rotating speed of the first fan 10, and sends the first impulse signal S1 generated by the first fan 10 to the complex programmable logic device 14.

In one embodiment, the hardware monitoring module 18 is connected to a first temperature sensor 20. The hardware monitoring module 18 receives temperature monitoring information of a central processing unit through the first temperature sensor 20 and sends the temperature monitoring information of the central processing unit to the complex programmable logic device 14. The complex programmable logic device 14 generates the signal of first fan rotating speed according to the temperature monitoring information of the central processing unit for adjusting the rotating speed of the first fan. In other words, the first temperature sensor 20 is capable of detecting the temperature of the central processing unit through one or more thermal diodes for generating the temperature monitoring information of the central processing unit and sends the temperature monitoring information to the hardware monitoring module 18. The hardware monitoring module 18 further sends the temperature monitoring information to the complex programmable logic device 14, so that the complex programmable logic device 14 is capable of adjusting the rotating speed of the first fan 10 according to the temperature monitoring information. For example, if the temperature monitoring information indicates that the current temperature of the central processing unit is high, the complex programmable logic device 14 generates the first fan rotating speed to raise the rotating speed of the first fan 10. Therefore, the cooling capability of the first fan 10 is raised so that the processing units will not be damaged because of the high temperature during the operations.

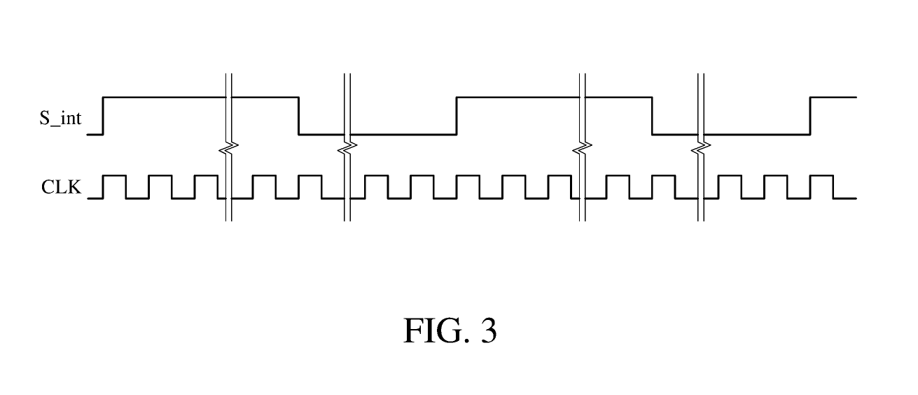

Please refer to FIG. 1 and FIG. 3. FIG. 3 is a schematic diagram for counting a time period of a first initial impulse signal according to one embodiment of the present disclosure. In this embodiment, when the first fan 10 starts to operate, the hardware monitoring module 18 drives the first fan 10 to operate according to a predetermined initial rotating speed and the first fan 10 generates a first initial impulse signal S_int having a first initial impulse frequency value. The first initial impulse frequency value is less than the first peak, which means that the first initial impulse frequency value is less than the predetermined maximum peak. The complex programmable logic device 14 receives the first initial impulse signal S_int through the hardware monitoring module 18 and counts a time period of continuously receiving the first initial impulse signal S_int. When the complex programmable logic device 14 determines that the time period of continuously receiving the first initial impulse signal reaches a predetermined threshold, the complex programmable logic device 14 generates a first fan normality signal. As shown in the embodiment of FIG. 3, the complex programmable logic device 14 receives the first initial impulse signal S_int through the hardware monitoring module 18. In some embodiments, the first initial impulse frequency value of the first initial impulse signal S_int is 2.5 Hz, and the complex programmable logic device 14 counts the first initial impulse signal S_int according to clock frequency CLK (128 Hz) to generate the time period of continuously receiving the first initial impulse signal S_int. When the complex programmable logic device 14 determines that the time period of continuously receiving the first initial impulse signal S_int reaches the predetermined threshold (5 seconds), the complex programmable logic device 14 generates the first fan normality signal and sends the first fan normality signal to the fan status notification module 16. As shown in FIG. 3, assume that the time period of receiving the first initial impulse signal S_int is 5 seconds, which reaches the predetermined threshold. In other words, the first fan keeps operating at a rotating speed lower than the minimum predetermined rotating speed for the predetermined threshold which is 5 seconds. Therefore, the complex programmable logic device 14 generates the first fan normality signal. The fan status notification module 16 displays the first fan normality status notification (e.g. green lights) according to the first fan normality signal to indicate that the first fan 10 operates normally. In another embodiment, after the first fan 10 starts to operate and receives the signal of first fan rotating speed, when the complex programmable logic device 14 determines the first impulse frequency value is less than the first peak and greater than or equal to a third peak, which means the complex programmable logic device 14 determines that the first impulse frequency value is less than the predetermined maximum peak and greater than or equal to the predetermined minimum peak, the fan status notification module 16 keeps displaying the first fan normality status notification. Specifically, when the first impulse frequency value is less than the first peak, it is indicated that the rotating speed of the first fan 10 is less than or equal to the predetermined maximum rotating speed. When the first impulse frequency value is not less than the third peak, it is indicated that the rotating speed of the first fan 10 is greater than or equal to a predetermined minimum rotating speed. More specifically, in this embodiment, when the rotating speed of the first fan 10 is greater than the predetermined minimum rotating speed and not greater than the predetermined maximum rotating speed, the complex programmable logic device 14 determines that the first fan 10 operates normally, so that the fan status notification module 16 keeps displaying the first fan normality status notification. In this embodiment, the first peak represents the predetermined maximum peak of the first impulse signal and the third peak represents the predetermined minimum peak of the first impulse signal. The first peak is greater than the third peak.

In one embodiment, as shown in FIG. 1, the hardware monitoring module 18 and the complex programmable logic device 14 are electrically connected to the south bridge 22 respectively. When the first fan 10 starts to operate, the south bridge 22 searches for fan controlling data in a basic input/output system module 30 and sends the fan controlling data to the hardware monitoring module 18 and the complex programmable logic device 14. Specifically, when the system is turned on, the south bridge 22 acquires the fan controlling data from the basic input/output system module 30 including the predetermined initial rotating speed, the predetermined threshold, the first peak and the first predetermined time value regarding the first fan 10. The south bridge 22 further sends the fan controlling data to the hardware monitoring module 18 and the complex programmable logic device 14 for configurations.

In one embodiment, the fan monitoring system 1 includes the second fan 12 as shown in FIG. 1. The second fan 12 is disposed in an air channel different from another air channel where the first fan is disposed. In other words, in an example, the second fan 12 is capable of cooling the whole system through a corresponding air channel, and the first fan 10 is capable of cooling one of components (e.g. CPU) through another corresponding air channel. In this embodiment, the second fan 12 is connected to the complex programmable logic device 14 through the hardware monitoring module 18. The second fan 12 receives a signal of second fan rotating speed from the complex programmable logic device 14 and operates according to the signal of second fan rotating speed. When the second fan 12 operates, a second impulse signal is generated. The second impulse signal has a second impulse frequency value.

When the complex programmable logic device 14 receives the second impulse frequency value, the complex programmable logic device 14 counts a time period of continuously receiving the second impulse signal having the second impulse frequency value remaining consistent. When the complex programmable logic device 14 determines the second impulse frequency value reaches the second peak, and the time period of continuously receiving the second impulse signal having the second impulse frequency value remaining consistent is greater than a second predetermined time value, the complex programmable logic device 14 determines that the second fan 12 operates abnormally and generates a second fan error signal. The description indicating that how the complex programmable logic device 14 determines the second impulse frequency value reaches the second peak in this embodiment is similar to the descriptions in the aforementioned embodiments, so no more repeated here. The fan status notification module 16 displays a second fan error status notification when receiving the second fan error signal. The second peak is the predetermined maximum peak of the signal impulse signal.

In one embodiment, as shown in FIG. 1, the fan monitoring system 1 includes a plurality of system temperature sensors 24, 26. The complex programmable logic device 14 is electrically connected to the system temperature sensors 24, 26 for receiving monitoring information of system temperature. In this embodiment, the system temperature sensor 24 includes a mainboard temperature sensor 241 disposed near the mainboard area 28 for monitoring the temperature of the mainboard area 28. Specifically, a plurality of expansion cards is correspondingly connected to a plurality of expansion slots of the mainboard area 28. Temperature is generated when those expansion cards operate. The mainboard temperature sensor 241 is configured to monitor the temperature of those expansion cards in the mainboard area 28. The complex programmable logic device 14 is capable of receiving the information of monitoring system temperature related to the mainboard area 28 through the mainboard temperature sensor 241. The system temperature sensor 26 includes a south bridge temperature sensor 261 near the south bridge 22 for monitoring the temperature of the south bridge 22. The complex programmable logic device 14 acquires the information of monitoring system temperature related to the south bridge 22 through the south bridge sensor 261. In one example, the complex programmable logic device 14 generates a signal of second fan rotating speed for controlling the operation of the second fan 12.

In one embodiment, when the complex programmable logic device 14 generates the first fan error signal or the second fan error signal, the complex programmable logic device 14 generates a shutdown command, For example, when the rotating speed of the first fan 10 or the rotating speed of the second fan 12 is less than their own predetermined minimum rotating speed, components (e.g. CPUs) in the server would have a difficulty of cooling. Therefore, the complex programmable logic device 14 generates the shutdown command and sends the shutdown command to the mainboard system module 32. The mainboard system module 32 further turns off the server according to the shutdown command, so that the poor efficiencies of components in the server caused by cooling difficulties could be avoided.

Based on the descriptions, in the operation of the fan monitoring system, the complex programmable logic device counts the time period of the impulse signal of the fan, and determines the status of the fan by determining whether the impulse frequency value reaches the peak value. Moreover, the fan status notification module displays the current status of the fan. Therefore, the controls and the displays for operations of the fan in the whole server can be completed by using the complex programmable logic device instead of the traditional BMC.

What is claimed is:

1. A fan monitoring system adapted to a server and comprising:
a first fan for receiving a signal of first fan rotating speed, operating according to the signal of first fan rotating speed, and generating a first impulse signal having a first impulse frequency value;
a complex programmable logic device communicatively connected to the first fan, for receiving the first impulse frequency value, counting a time period of continuously receiving the first impulse signal having the first impulse frequency value remaining consistent, and the complex programmable logic device determining that the first fan operates abnormally and generating a first fan error signal when determining that the first impulse frequency value reaches a first peak and the time period of continuously receiving the first impulse signal having the first impulse frequency value remaining consistent is greater than a first predetermined time value; and
a fan status notification module electrically connected to the complex programmable logic device and configured to display a first fan error status notification when receiving the first fan error signal.

2. The fan monitoring system according to claim 1, further comprising:
a hardware monitoring module electrically connected to the complex programmable logic device and the first fan respectively;
wherein the complex programmable logic device receives the first impulse signal and sends the signal of first fan rotating speed to the first fan for controlling an operation status of the first fan through the hardware monitoring module.

3. The fan monitoring system according to claim 2, wherein the hardware monitoring module is connected to at least one first temperature sensor, the hardware monitoring module receives temperature monitoring information of a central processing unit through the at least one first temperature sensor and sends the temperature monitoring information of the central processing unit to the complex programmable logic device, and the complex programmable logic device generates the signal of first fan rotating speed according to the temperature monitoring information of the central processing unit for adjusting the operation status of the first fan.

4. The fan monitoring system according to claim 2, wherein the first fan is driven by the hardware monitoring module to operate at a predetermined initial rotating speed when the first fan starts to operate, the first fan generates an first initial impulse signal having a first initial impulse frequency value which is less than the first peak, the complex programmable logic device receives the first initial impulse signal through the hardware monitoring module and counts a time period of continuously receiving the first initial impulse signal, the complex programmable logic device generates a first fan normality signal and sends the first normality fan signal to the fan status notification module when determining the time period of continuously receiving the first initial impulse signal reaches a predetermined threshold, and the fan status notification module, according to the first fan normal signal, displays a first fan normality status notification for indicating that the first fan operates normally.

5. The fan monitoring system according to claim 4, wherein after the first fan starts to operate and receives the signal of first fan rotating speed, the fan status notification module continuously displays the first fan normality status notification as the complex programmable logic device determines that the first impulse frequency value is less than the first peak and greater than or equal to a third peak.

6. The fan monitoring system according to claim 4, wherein the hardware monitoring module and the complex programmable logic device are respectively connected to a south bridge, the south bridge searches for fan controlling data in a basic input/output system module and sends the fan controlling data to the hardware monitoring module and the complex programmable logic device when the first fan starts to operate, and the fan controlling data comprises the predetermined initial rotating speed, the predetermined threshold, the first peak and the first predetermined time value.

7. The fan monitoring system according to claim 2, further comprising:
a second fan disposed in an air channel different from another air channel where the first fan is disposed, and electrically connected to the complex programmable logic device through the hardware monitoring module, for operating according to a signal of second fan rotating speed received from the complex programmable logic device, generating a second impulse signal having a second impulse frequency value;
wherein the complex programmable logic device counts a time period of continuously receiving the second impulse signal having the second impulse frequency value remaining consistent, the complex programmable logic device determines that the second fan operates abnormally and generates a second fan error signal when determining that the second impulse frequency value reaches a second peak and the time period of continuously receiving the first impulse signal having the first impulse frequency value remaining consistent is greater than a second predetermined time value, and the fan status notification module receives the second fan error signal and displays a second fan error status notification.

8. The fan monitoring system according to claim 7, further comprising:
a plurality of system temperature sensors;
wherein the complex programmable logic device is electrically connected to the plurality of system temperature sensors for receiving information of monitoring system temperature, and the complex programmable logic device generates the signal of second fan rotating speed according to the information of monitoring system temperature for controlling an operation status of the second fan.

9. The fan monitoring system according to claim 8, wherein at least two of the plurality of system temperature sensors comprises at least one mainboard temperature sensor for monitoring a mainboard temperature and at least one south bridge temperature sensor for monitoring a south bridge temperature.

10. The fan monitoring system according to claim 7, wherein the complex programmable logic device generates a shutdown command and sends the shutdown command to a mainboard system module for turning off the server when generating the first fan error signal or the second fan error signal.
